(19) United States
(12) Patent Application Publication
(10) Pub. No.: US 2009/0300377 A1
(43) Pub. Date: Dec. 3, 2009

(54) Computer system for Managing Power consumption and Method Thereof

(76) Inventors: Kuo-Chung Kao, Taipei City (TW); Changfei Dai, Taipei City (TW); Quan Zhao, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/464,863

(22) Filed: May 12, 2009

(30) Foreign Application Priority Data
May 29, 2008 (TW) 097119879

(51) Int. Cl. G06F 1/26

(52) U.S. Cl. 713/300

(57) ABSTRACT

A computer system for managing power consumption includes a power supply, a current detecting module, a power control module and a feedback control module. The power supply is used for outputting a system voltage according to a feedback signal. The current detecting module senses a system current to generate system current information. The power control module includes a calculating unit and a user interface. The calculating unit calculates a power consumption of the computer system according to the system current information or the system voltage. The user interface includes a plurality of power adjusting functions, and is used for displaying the system current information and the power consumption. In addition, the user interface generates a voltage control signal according to a power adjusting function selected from the plurality of power adjusting functions. The feedback control module adjusts the feedback signal according to the voltage control signal.

### BACKGROUND OF THE INVENTION

1. Field of the Invention

The present invention relates to a computer system, and more particularly, to a computer system for managing power consumption and method.

2. Description of the Prior Art

In a nowadays computer system, a system or a workload condition of a central processor unit is displayed through an application software in an operating system. The workload condition is usually evaluated according to an amount of threads that is presently executed by the central processor unit and a usage degree of a memory. Therefore, system loading information is calculated by means of pure application software, but not measurement of a real hardware work condition. Therefore, the computer system of the prior art cannot completely reflect the system loading.

### SUMMARY OF THE INVENTION

Therefore, the present invention provides a computer system for managing power consumption by sensing a system current with a hardware device of the computer system.

The present invention discloses a computer system for managing power consumption. The computer system further includes a power supply, a current detecting module, a power control module, and a feedback control module. The power supply device is used for outputting a system voltage according to a feedback signal. The current detecting module is used for sensing a system current of the computer system to generate system current information. The power control module is coupled to the power supply device and the current detecting module, and includes a calculating unit and a user interface.

The calculating unit is used for calculating a power consumption of the computer system according to the system current information or the system voltage. The user interface includes a plurality of power adjusting functions. The user interface is used for displaying the system current information and the power consumption of the computer system, and generating a voltage control signal according to a power adjusting function. The feedback control module, coupled to the power control module and the power supply device, is used for generating the feedback signal, and adjusts the feedback signal according to the voltage control signal.

The present invention further discloses a method of managing power consumption for a computer system. The computer system includes a power supply device for adjusting a system voltage according to a feedback signal. The method includes providing a plurality of power adjusting functions, sensing a system current of the computer system to generate system current information, calculating a power consumption of the computer system according to the system current information or the system voltage, generating a voltage control signal according to a power adjusting function, adjusting the feedback signal according to the voltage control signal, and displaying the system current information and the power consumption of the computer system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a computer system according to an embodiment of the present invention.

FIG. 2 is a flow diagram of a process according to an embodiment of the present invention.

### DETAILED DESCRIPTION

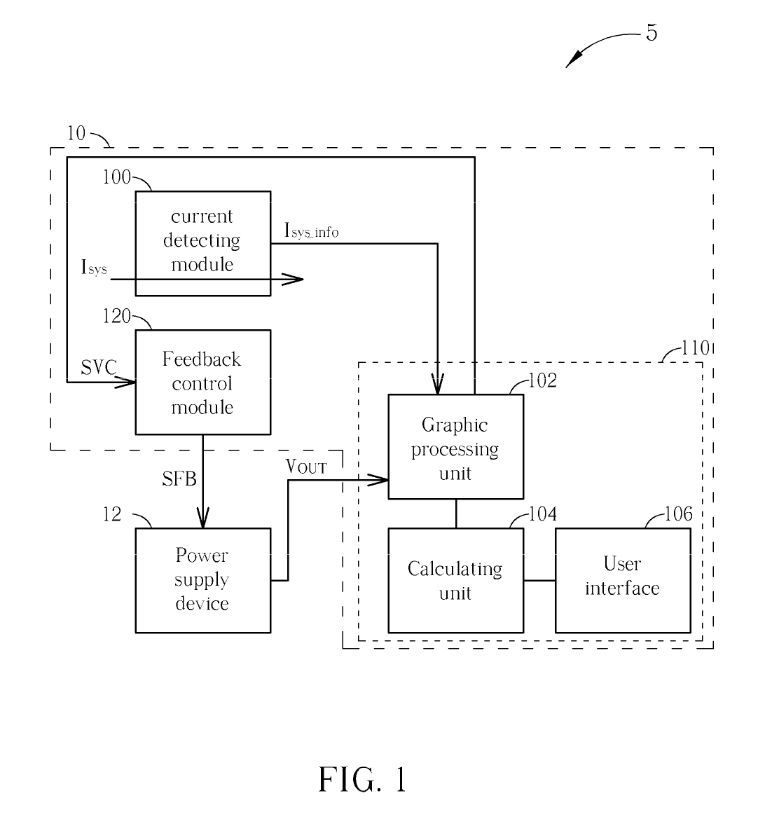

Please refer to FIG. 1, which is a functional block diagram of a computer system 5 for managing power consumption according to an embodiment of the present invention. The computer system 5 is operated in a Microsoft, a Mac or a Linux operating system, and includes a power supply device 12 for outputting a system voltage (V_{OUT}) according to a feedback signal (SFB). In addition, the computer system 5 includes an electronic device 10, which displays a power consumption state of the computer system 5 and provides a plurality of functions for adjusting power consumption of the computer system 5. The electronic device 10 includes a current detecting module 100, a power control module 110, and a feedback control module 120. The current detecting module 100 is used for sensing a system current (I_{sys}) flowing through the current detecting module 100 to generate system current information (I_{sys}_{_{—}}_{info}). The power control module 110 is coupled to a power supply device 12 and the current detecting module 100, and includes a graphic processing unit (GPU) 102, a calculating unit 104 and a user interface 106. The graphic processing unit 102 is used for receiving the system voltage (V_{OUT}) and the system current information (I_{sys}_{_{—}}_{info}), and thereby outputting a voltage control signal (SVC) generated by the user interface 106 to the feedback control module 120. The calculating unit 104 is coupled to the graphic processing unit 102, and used for calculating a power consumption of the computer system 5 according to the system current information (I_{sys}_{_{—}}_{info}) or the system voltage (V_{OUT}). The user interface 106 is coupled to the calculating unit 104 and the graphic processing unit 102, and used for displaying the system current information (I_{sys}_{_{—}}_{info}) and the power consumption of the computer. In addition, the user interface 106 includes a plurality of power adjusting functions, and generates a voltage control signal (SVC) according to a power adjusting function. The feedback control module 120 is used for generating the feedback signal (SFB) for the power supply device 12, and adjusts the feedback signal (SFB) according to signal of the voltage control signal (SVC). Therefore, the power supply device 12 adjusts the system voltage (V_{OUT}) when the feedback signal (SFB) is adjusted, so as to control the power consumption of the computer system 5.

The user interface 106 displays the system current information (I_{sys}_{_{—}}_{info}) and instantaneous power consumption or average power consumption. Preferably, the system current information (I_{sys}_{_{—}}_{info}) and the instantaneous power consumption can be recorded continuously and displayed by a waveform diagram. The power adjusting functions of the user interface 106 include a voltage up function and a voltage down function. When the voltage up function is selected, the feedback control module 120 adjusts the feedback signal (SFB) according to the voltage control signal (SVC), so as to trigger the power supply device 12 to increase the system voltage (V_{OUT}) according to the adjusted feedback signal (SFB) for increasing the power consumption. On the contrary, when the voltage down function is selected, the power supply device 12 decreases the system voltage (V_{OUT}) according to the adjusted feedback signal (SFB), so as to lowering the power consumption. In addition, the power supply device 12 can include a plurality of power supplies, or a power supply whose power phase can be adjusted. In this condition, the power adjusting functions of the user interface 106 can be added with a special power saving function allowing the power supply device 12 to select the number of the power supplies or the number of power output phases according to the adjusted feedback signal (SFB), in order to change the power consumption of the computer system 5.

Therefore, through the user interface 106, a user can know the system current information (I_{sys}_{_{—}}_{info}) and a change condition of the power consumption and thereby select a proper power adjusting function. Or the computer system 5 determines the power adjusting function to use according to the system current information (I_{sys}_{_{—}}_{info}) or the power consumption.

Preferably, the current detecting module 100 senses the system current (I_{sys}) according to variance of an input voltage that is not shown in FIG. 1. The input voltage is obtained by adjusting the feedback signal (SFB) through a voltage regulator and thereby adjusts the system voltage (V_{OUT}) and affects the system current (I_{sys}). In other words, the voltage regulator uses the feedback signal (SFB) as an input reference signal to change the input voltage of the current detecting module 100 and thereby generates the corresponding system current (I_{sys}).

In electronic device 10, the current detecting module 100 is a hardware circuit which can sense a current intensity and variance more precisely than pure software applications, so the power consumption calculated by the calculating unit 104 is reliable.

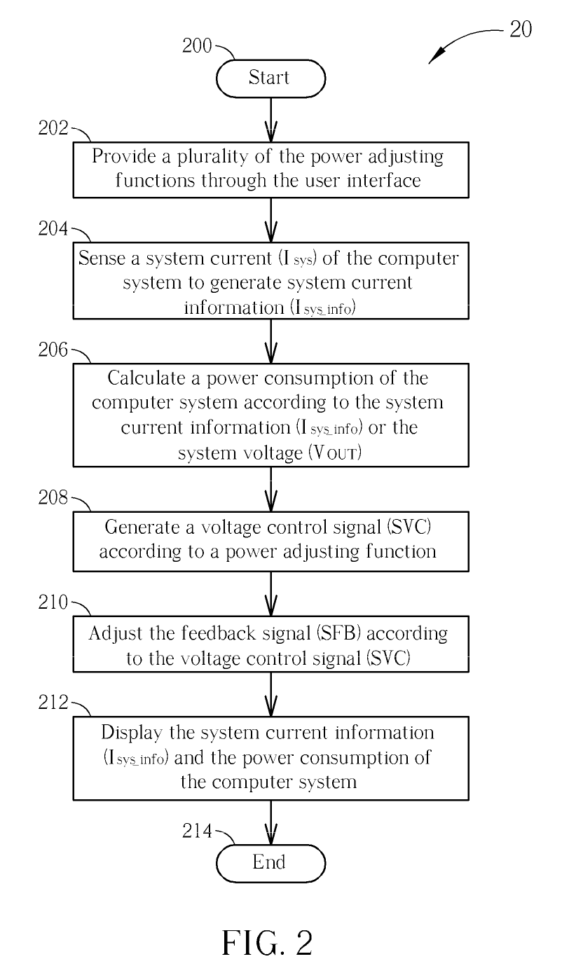

FIG. 2 is a flow diagram of a process 20 according to FIG. 1. The process 20 is realized by the computer system 5 which is operated in a Microsoft, a Mac or a Linux operating system, for managing the power consumption of the compute system 5. The process 20 includes following steps:

Step 200: Start.

Step 202: Provide a plurality of the power adjusting functions through the user interface 106.

Step 204: Sense a system current (I_{sys}) of the computer system 5 to generate system current information (I_{sys}_{_{—}}_{info}).

Step 206: Calculate a power consumption of the computer system 5 according to the system current information (I_{sys}_{_{—}}_{info}) or the system voltage (V_{OUT}).

Step 208: Generate a voltage control signal (SVC) according to a power adjusting function.

Step 210: Adjust the feedback signal (SFB) according to the voltage control signal (SVC).

Step 212: Display the system current information (I_{sys}_{_{—}}_{info}) and the power consumption of the computer system.

Step 214: End.

According to process 20, the embodiment of the present invention generates the system current information (I_{sys}_{_{—}}_{info}) via constantly sensing the system current (I_{sys}) and further calculates the power consumption according to the system current information (I_{sys}_{_{—}}_{info}) or the system voltage (V_{OUT}). The system current information (I_{sys}_{_{—}}_{info}) and the power consumption of the computer system is displayed via the user interface 106, and preferably displayed via a waveform diagram. In addition, the voltage control signal (SVC) generated via the power adjusting function provided through the user interface 106is used for adjusting the feedback signal (SFB), so as to control the power consumption. Preferably, the power adjusting function is determined according to the system current information (I_{sys}_{_{—}}_{info}). From above, the system current information (I_{sys}_{_{—}}_{info}) affects the voltage control signal (SVC), and a change of the voltage control signal (SVC) causes changes of the system voltage (V_{OUT}), the feedback signal (SFB), and the system current information (I_{sys}_{_{—}}_{info}). Since the process 20 is realized by computer system 5, the detailed operating process can be referred to the description in the FIG. 1.

In conclusion, the embodiments of the present invention utilize hardware device to sense the system current to precisely obtain the power consumption condition and thereby adjust the power consumption appropriately.

Those skilled in the art will readily observe that numerous modifications and alterations of the device and method may be made while retaining the teachings of the invention.

What is claimed is:

1. A computer system for managing power consumption, the computer system comprising:
a power supply device for outputting a system voltage according to a feedback signal;
a current detecting module for sensing a system current of the computer system to generate system current information;
a power control module, coupled to the power supply device and the current detecting module, comprising:
a calculating unit for calculating a power consumption related to the computer system according to the system current information or the system voltage; and
an user interface comprising a power adjusting function, the user interface used for displaying the system current information and the power consumption, and generating a voltage control signal according to the power adjusting function; and
a feedback control module coupled to the power control module and the power supply device, for generating the feedback signal, and adjusting the feedback signal according to the voltage control signal.

2. The computer system of claim 1, wherein the user interface uses a waveform diagram to display the system current information and the power consumption.

3. The computer system of claim 1, wherein the power adjusting function of the computer system comprises an voltage up function and a voltage down function.

4. The computer system of claim 3, wherein the feedback control module adjusts the feedback signal according to the voltage control signal when the power adjusting function is set to the voltage up function, so as to trigger the power supply device to increase the system voltage according to the adjusted feedback signal.

5. The computer system of claim 3, wherein the feedback control module adjusts the feedback signal according to the voltage control signal when the power adjusting function is set to the voltage down function, so as to trigger the power supply device to decrease the system voltage according to the adjusted feedback signal.

6. The computer system of claim 1, wherein the power adjusting function is determined according to the system current information.

7. The computer system of claim 1, wherein the current detecting module senses the system current of the computer system according to an input voltage, obtained via adjusting the feedback signal, to generate the system current information.

8. The computer system of claim 1, wherein the computer system is operated in a Microsoft operating system, a Mac operating system, or a Linux operating system.

9. The computer system of claim 1, wherein the power consumption is instantaneous power consumption or average power consumption.

10. A method of managing power consumption for a computer system comprising a power supply device for adjusting a system voltage according to a feedback signal, the method comprising:
sensing a system current of the computer system to generate system current information;
calculating a power consumption of the computer system according to the system current information or the system voltage;
generating a voltage control signal according to a power adjusting function;
adjusting the feedback signal according to the voltage control signal; and
displaying the system current information and the power consumption.

11. The method of claim 10, wherein displaying the system current information and the power consumption comprises using a waveform diagram to display the system current information and the power consumption.

12. The method of claim 10, wherein the power adjusting function comprises a voltage up function and a voltage down function.

13. The method of claim 12, wherein adjusting the feedback signal according to the voltage control signal when the power adjusting function is set to the voltage up function, so as to increase the system voltage according to the adjusted feedback signal.

14. The method of claim 12, wherein adjusting the feedback signal according to the voltage control signal when the power adjusting function is set to the down voltage function, so as to decrease the system voltage according to the adjusted feedback signal.

15. The method of claim 10, wherein the power adjusting function is determined according to the system current information.

16. The method of claim 10, wherein sensing the system current of the computer system to generate the system current information comprises sensing the system current of the computer system according to an input voltage, obtained via adjusting the feedback signal, to generate the system current information.

17. The method of claim 10, wherein the computer system is operated in a Microsoft operating system, a Mac operating system, or a Linux operating system.

18. The method of claim 10, wherein the power consumption is an instantaneous power consumption or an average power consumption.
